(19) United States
(12) Patent Application Publication
(10) Pub. No.: US 2024/0251853 A1
(43) Pub. Date: Aug. 1, 2024

(54) ATOMIZING STRUCTURE AND MANUFACTURING METHOD THEREOF

(71) Applicant: SMISS TECHNOLOGY CO., LTD., Shenzhen (CN)

(72) Inventors: Jiatai CHEN, Shenzhen (CN); Shengwen ZHOU, Shenzhen (CN); Huina ZHANG, Shenzhen (CN)

(21) Appl. No.: 17/778,409

(22) PCT Filed: Jan. 13, 2022
(86) PCT No.: PCT/CN2022/071801

§ 371 Date: May 20, 2022

(30) Foreign Application Priority Data
Aug. 26, 2021 (CN) 202110991303.4

(51) Int. Cl. A24F 40/46; A24F 40/70

(52) U.S. Cl. CPC A24F 40/46; A24F 40/70

(57) ABSTRACT

An atomizing structure includes a conductive pin and a heating piece. The conductive pin includes a fixing portion, a bending portion and a clamping portion. The bending portion connects the fixing portion and the clamping portion. The heating piece is fixedly connected to the fixing portion, and a gap between the clamping portion and the heating piece is configured to clamp the first cotton piece, such that the first cotton piece is attached to the heating piece. The heating piece generates heat to evaporate and atomize liquid adsorbed by the first cotton piece, and a side of the first cotton piece away from the heating piece is configured to be attached to a second cotton piece.

### CROSS-REFERENCE OF RELATED APPLICATIONS

This application is a US National Stage of International Application No. PCT/CN2022/071801, filed on Jan. 13, 2022, which claims the priority of the Chinese patent application No. 2021109913034, titled “ATOMIZING STRUCTURE AND MANUFACTURING METHOD”, filed on Aug. 26, 2021, the entire contents of which are incorporated herein in their entireties.

### FIELD

The present disclosure relates to the field of atomizers, and more particularly, to an atomizing structure and a manufacturing method thereof.

### BACKGROUND

The atomizer is an important component in electronic cigarette products. The atomizer generally includes an liquid-conducting cotton and a heating piece. Liquid is absorbed by the liquid-conducting cotton. During the power-on process, the heating piece generates heat and atomizes the liquid.

A method of manufacturing the current common atomizing structure includes the following steps. First, a back surface of the heating piece is placed flat on a front surface of the liquid-conducting cotton, and then a temporary auxiliary forming cylindrical needle bar jig is placed on a front surface of the heating piece, and then the liquid-guiding cotton and the heating piece are wrapped into a required shape according to a shape of the needle bar jig, finally put the liquid-conducting cotton, the heating piece and the needle bar jig into an assembly cavity of the fixing bracket at the same time, and pass the two conductive pins through the holes opened on the fixing seat respectively, and finally form a fixation. After the assembly is completed, the needle bar jig is extracted to form a conventional atomizing structure.

However, in the atomizing structure described above, the heating piece is easily affected during assembly. For example, the heating piece may have an inner hole deformation when the needle bar jig is extracted, resulting in that the deformed heating piece cannot be completely attached to the liquid-guiding cotton, resulting in extremely high temperatures during operation, which leads to the phenomenon of “burning” or “dry burning”.

### SUMMARY

According to some embodiments, an atomizing structure and a manufacturing method thereof are provided.

An atomizing structure includes a conductive pin and a heating piece. The conductive pin includes a fixing portion, a bending portion and a clamping portion. The bending portion connects the fixing portion and the clamping portion. The heating piece is fixedly connected to the fixing portion, and a gap between the clamping portion and the heating piece is configured to clamp a first cotton piece, and the first cotton piece is attached to the heating piece. The heating piece generates heat to evaporate and atomize liquid adsorbed by the first cotton piece, and a side of the first cotton piece away from the heating piece is configured to be attached to a second cotton piece.

A method of manufacturing a atomizing structure includes:
connecting one end of a conductive pin to a heating piece;
bending the conductive pin to form a gap between a clamping portion of the conductive pin and the heating piece;
inserting a first cotton piece into the gap between the clamping portion and the heating piece; and
further bending the conductive pin, and the first cotton piece is clamped between the clamping portion and the heating piece.

A method of manufacturing the atomizing structure includes:
forming a gap between the first cotton piece and the second cotton piece;
inserting the clamping portion into the gap between the first cotton piece and the second cotton piece; and
bringing the clamping portion and the heating piece close to each other, and the clamping portion and the heating piece clamp the first cotton piece.

The details of one or more embodiments of the present disclosure are set forth in the following drawings and description. Embodiments of the present disclosure will become apparent from the description, drawings and claims.

### BRIEF DESCRIPTION OF THE DRAWINGS

In order to explain the embodiments of the present disclosure more clearly, the following briefly introduces the accompanying drawings that need to be used in the description of the embodiments. The drawings in the following description are only for the present disclosure. In some embodiments, other drawings can also be obtained according to these drawings.

FIG. 1 is a perspective view of an atomizing structure according to an embodiment;

FIG. 2 is a perspective view of the atomizing structure shown in FIG. 1 after a first cotton piece is omitted;

FIG. 3 is the partial enlarged view of portion III in FIG. 2;

FIG. 4 is a perspective view of a heating piece and the first cotton piece provided in a packaging body according to an embodiment;

FIG. 5 is a perspective view of FIG. 4 viewed from another angle;

FIG. 6 is a cross-sectional view of an atomizer according to an embodiment.

### DETAILED DESCRIPTION OF THE EMBODIMENTS

The present disclosure will be further described in detail below with reference to the accompanying drawings and embodiments. It should be understood that the specific embodiments described herein are only used to explain the present disclosure, but not to limit the present disclosure.

It should be noted that when an element is referred to as being “fixed to” or “disposed on” another element, it can be directly on the other element or indirectly on the other element. When an element is referred to as being “connected to” another element, it can be directly connected to the other element or indirectly connected to the other element.

In addition, the terms “first” and “second” are only used for description purposes, and cannot be understood as indicating or implying relative importance or implicitly indicating the number of the indicated embodiments. Thus, a feature defined as “first” or “second” may expressly or implicitly include one or more of that feature. In the description of the present disclosure, “plurality” means two or more, unless otherwise expressly and specifically defined. “Several” means one or more than one, unless expressly specifically defined otherwise.

In the description of the present disclosure, it should be understood that the orientation or positional relationship indicated by the terms “center”, “length”, “width”, “thickness”, “upper”, “lower”, “front”, “rear”, “left”, “right”, “vertical”, “horizontal”, “top”, “bottom”, “inside”, “outside”, etc. is based on the orientation or positional relationship shown in the drawings, and is only for convenience to described the present disclosure and simplified the descriptions without indicating or implying that the device or element referred to must have a particular orientation, or be constructed and operate in a particular orientation, and therefore should not be construed as limiting the present disclosure.

In the description of the present disclosure, it should be noted that the terms “installed”, “connected together” and “connected to” should be understood in a broad sense, unless otherwise expressly specified and limited, for example, it may be a fixed connection or a detachable connection, or integral connection; it may be mechanical connection or electrical connection; it may be direct connection or indirect connection via an intermediate medium, or it may be internal communication between two elements or an interaction relationship between two elements. The specific meaning of the aforementioned terms in the present disclosure can be understood according to specific situations.

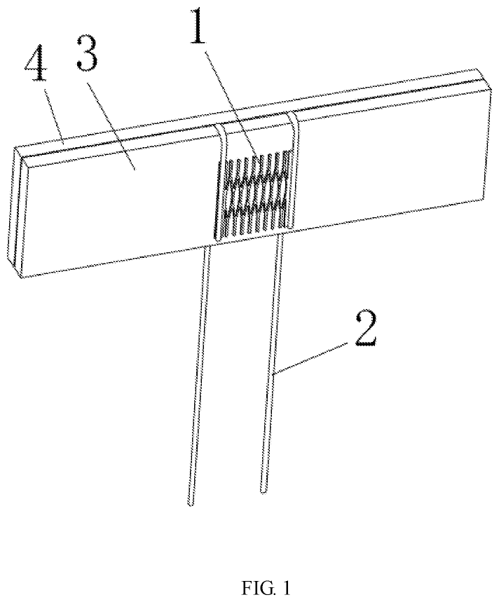

Referring to FIG. 1, an atomizing structure according to a specific embodiment includes a heating piece 1, two conductive pins 2, a first cotton piece 3, and a second cotton piece 4. The conductive pins 2 are configured to be connected to an anode and a cathode of a power supply. The heating piece 1 is electrically connected to the conductive pins 2, and is connected to the anode and the cathode of the power supply via the conductive pins 2 to realize heating. The first cotton piece 3 can absorb liquid to be evaporated, such as liquid of the electronic cigarette. The conductive pins 2 clamp the first cotton piece 3, and the first cotton piece 3 can be attached to the heating piece 1. After the first cotton piece 3 absorbs the liquid, the heat generated by the heating piece 1 can evaporate and atomize the liquid adsorbed in the first cotton piece 3.

In one embodiment, the heating piece 1 may be a metal mesh for conducting electricity and generating heat. The two conductive pins 2 are located at both ends of the heating piece 1, respectively. The atomizing structure is assembled in an atomizer and is a part of the atomizer. The atomizer is usually assembled in an electronic cigarette and is a part of the electronic cigarette. The conductive pins 2 are made of conductive material, which can be connected to an external power supply or a battery of the electronic cigarette, which can be selected according to the actual situation. According to the aforementioned atomizing structure, by using the clamping effect of the conductive pins 2, the seamless attaching between the heating piece 1 and the first cotton piece 3 is realized, and the heating piece 1 can completely transfer heat to the first cotton piece 3, and the liquid on the first cotton piece 3 is evaporated and atomized to prevent the first cotton piece 3 from being burned or the heating piece 1 from dry-burning due to a gap caused by improper attaching.

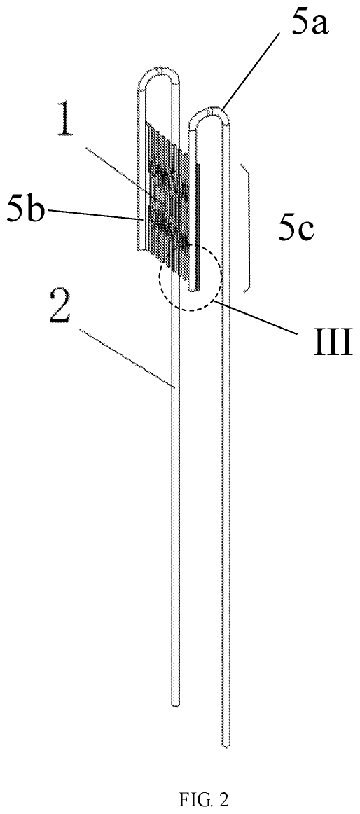

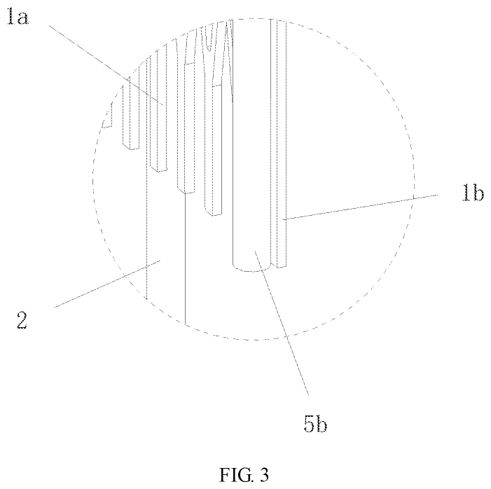

Referring to FIG. 2 and FIG. 3, further, the conductive pin 2 includes a bending portion 5a, a fixing portion 5b, and a clamping portion 5c. The heating piece 1 has an inner side and an outer side, and the fixing portion 5b is welded to the outer side of the heating piece 1. In one embodiment, the heating piece 1 includes a metal mesh 1a and two electrode portions 1b located on both sides of the metal mesh 1a, respectively. The clamping portion 5c and the electrode portion 1b are parallel to each other. The fixing portion 5b is welded to a side of the electrode portion 1b away from the clamping portion 5c. Lower portions of the two conductive pins 2, that is, an end thereof away from the fixing portion 5b, is configured to connect the anode and the cathode of the power supply. In this embodiment, the conductive pin 2 is made of conductive metal, which has ductility and can be bent into various shapes, therefore the bent conductive pin 2 has a bent portion 5a. Further, the bending portion 5a is located on an upper portion of the conductive pin 2, the clamping portion 5c is located in a middle portion of the conductive pin 2, and the bending portion 5a is formed by bending inward by the fixing portion 5b towards a direction close to the clamping portion 5c by 900 to 180°. The conductive pin 2 can be bent at any angle within this range, and the clamping portion 5c can clamp the first cotton piece 3 of different shapes firmly. The fixing portion 5b and an edge of the heating piece 1 can be fixedly connected, for example, by welding or the like. The clamping portion 5c is connected to the fixing portion 5b via the bending portion 5a. In one embodiment, the clamping portion 5c is a part of the conductive pin 2 facing the heating piece 1. In this embodiment, the specific form of the clamping portion 5c may be a long straight conductor parallel to a surface of the heating piece 1. There is a gap between the clamping portion 5c and the heating piece 1, and a vertical spacing of the gap is less than or equal to a thickness of the first cotton piece 3, and the first cotton piece 3 can be clamped between the clamping portion 5c and the heating piece 1, and the clamping portion 5c itself has an elastic force, so it can ensure that the heating piece 1 is completely attached to the first cotton piece 3. Since the clamping portion 5c is a part of the conductive pin 2, the first cotton piece 3 is not squeezed by an external structure, but is clamped by its own structure, which is simple and quick to operate, and saves cost and space. In other embodiments, the clamping portion 5c may also be a non-closed frame shape formed by bending, such as a U shape, etc., or a wave shape connected end to end, and the like. In addition, in this embodiment, the clamping portion 5c and the heating piece 1 are parallel to each other. When the clamping portion 5c and the heating piece 1 are parallel to each other, a clamping force thereof to the first cotton piece 3 is consistent, which ensures compactness of clamping and enables the first cotton piece 3 to be evenly attached to the heating piece 1 everywhere.

Referring to FIG. 1, the atomizing structure further includes a second cotton piece 4, and the second cotton piece 4 is attached to an outer side of the first cotton piece 3, that is, a side away from the heating piece 1. This embodiment adopts the structure design of double-layer cotton pieces, which increases an overall thickness of the cotton pieces, increases liquid storage capacity, and can provide a large amount of flue gas to meet the usage requirements. It should be understood that the atomizing structure may also include a third or more cotton pieces.

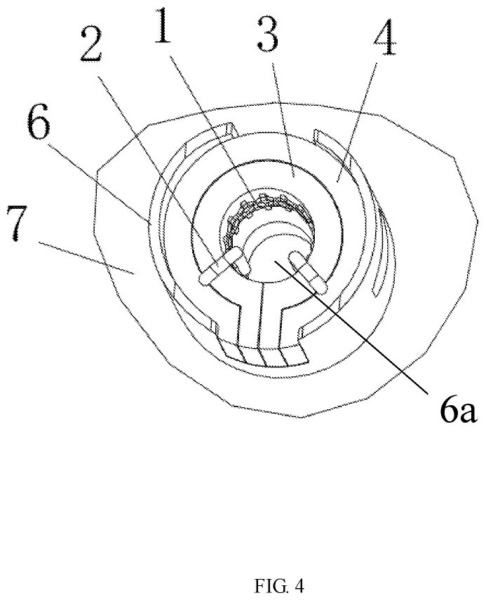

Referring to FIG. 4, the atomizing structure further includes a packaging body 6. The packaging body 6 is configured to fix the first cotton piece 3, the second cotton piece 4, and the heating piece 1. The packaging body 6 is of a circular hollow structure, the first cotton piece 3 and the second cotton piece 4 are connected end to end to form an annular shape, which can be accommodated in the packaging body 6, that is, the packaging body 6 surrounds the second cotton piece 4. The heating piece 1 is located in the inner circle, the first cotton piece 3 is located in the middle circle, the second cotton piece 4 is located in the outer circle, and a middle portion of the first cotton piece 3 is a flue gas channel 6a. After the heating piece 1 is energized and heated, gas formed by the atomization of the liquid can flow through the flue gas channel 6a.

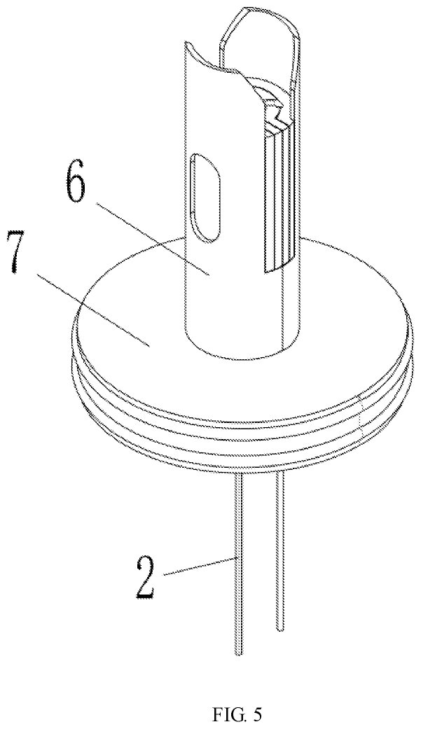

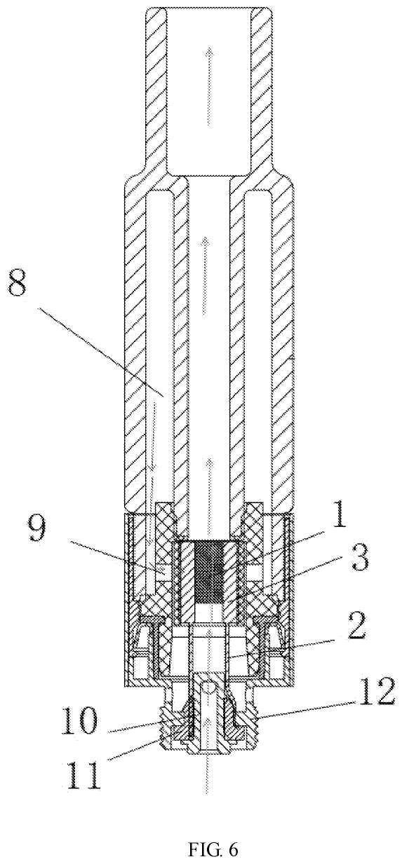

As shown in FIGS. 5 and 6, the atomizing structure is provided inside the atomizer, and the atomizer can be mounted in products such as electronic cigarettes. The packaging body 6 is mounted on the fixing seat 7 of the atomizer. The fixing seat 7 is provided with air holes and perforations. The air hole is in communication with the outside to provide an air circulation inlet. The conductive pins 2 are connected to the anode and the cathode of the power supply via through holes. The atomizer also includes a housing and a base. The base is mounted on a lower part of the housing. An upper portion of the housing is provided with a cigarette holder, a middle portion of the housing is provided with a flue gas channel, a liquid storage bin 8 is arranged in the housing, and the smoke liquid is stored in the liquid storage bin 8. The liquid storage bin 8 is in communication with the first cotton piece 3 via the liquid inlet hole 9 to supply liquid to the first cotton piece 3. Ends of the two conductive pins 2 are connected to the anode and the cathode of the power supply, respectively. One of the conductive pins 2 is connected to the anode pole 10, and the other of the conductive pins 2 is connected to a screw head 12. The screw head 12 and the anode pole 10 is isolated by an insulating pad 11. The screw head 12 is connected to the cathode pole of the power supply, the anode pole 10 is connected to the anode of the power supply, and the power supply realizes output power control via a circuit board.

The working principle of the atomizer with the aforementioned atomizing structure is as follows.

Liquid in the liquid storage bin 8 flows inward through the liquid inlet hole 9, and reaches an inner side of the first cotton piece 3 through the thickness of the first cotton piece 3. The liquid inside the first cotton piece 3 is heated and atomized by the heating piece 1 inside the first cotton piece 3, and the atomized liquid flows upward along the smoke channel 6a. Outside air flows in through an air intake hole of the base, passes upwards through an air hole of the fixing seat 7, and then the atomized liquid flows out through the inner side of the heating piece 1 along the flue gas channel 6a, and the outside air continues to enter, and the liquid is continuously atomized.

According to an embodiment, a method of manufacturing the aforementioned atomizing structure is also provided, which includes the following steps:

In step 1, one end of the conductive pin is connected to the heating piece.

In one embodiment, the fixing portion 5b of the conductive pin 2 is fixedly connected to the heating piece 1, for example, by welding.

In step 2, the conductive pins are bent to form a gap between the clamping portions of the conductive pins and the heating piece.

In one embodiment, the conductive pins 2 are bent in advance via the ductility of the conductive pins 2 to form a bending portion 5a and a clamping portion 5c, and a gap is formed between the clamping portion 5c and the heating piece 1. In some embodiments, the bending portion 5a of the conductive pin 2 has a shape of U, and the clamping portion 5c has a shape of a long straight rod-like structure.

In step 3, the first cotton piece is inserted between the clamping portion and the heating piece.

In one embodiment, the first cotton piece 3 is placed in the gap between the clamping portion 5c and the heating piece 1.

In step 4, the conductive pins are further bent, and the first cotton piece is clamped between the clamping portion and the heating piece.

In some embodiments, the aforementioned method further includes the following steps:

In step 5, the second cotton piece 4 is attached to the side of the first cotton piece 3 away from the heating piece 1.

In step 6, the first cotton piece 3, the second cotton piece 4 and the heating piece 1 are shaped into an annular shape via an auxiliary jig.

In one embodiment, the first cotton piece 3 and the heating piece 1 are rolled into an annular shape with the aid of the auxiliary jig. The auxiliary jig has a shape of a round bar, which can assist in winding.

In step 7, the first cotton piece 3 and the heating piece 1 forming an annular structure are placed in the packaging body 6, the auxiliary jig is removed, and the second cotton piece 4 abuts against the inner side of the packaging body 6.

In one embodiment, the first cotton piece 3, the heating piece 1 and the auxiliary jig are assembled in the packaging body 6 at the same time, and the auxiliary jig is pulled out, and the first cotton piece 3 and the heating piece 1 are wound in an annular shape inside the packaging body 6.

According to an embodiment, a method of manufacturing the aforementioned atomizing structure is also provided, which includes the following steps:
In step 1, a gap is formed between the first cotton piece 3 and the second cotton piece 4.
In step 2, the clamping portion 5c is inserted into the gap between the first cotton piece 3 and the second cotton piece 4.
In step 3, the clamping portion 5c and the heating piece 1 are moved close to each other, and the clamping portion 5c and the heating piece 1 clamp the first cotton piece 3.

In one embodiment, the conductive pins 2 can be bent via ductility of the conductive pins 2, and the clamping portion 5c and the heating piece 1 are close to each other, and then the first cotton piece 3 is placed between the clamping portion 5 and the heating piece 1.

Through the aforementioned method, the atomizing structure that can avoid dry burning of the heating piece 1 and burning of the first cotton piece can be quickly prepared. The heating piece 1 has conductive pins 2, which are configured to connect the anode and the cathode of the power supply, and generate heat after being energized. Since the first cotton piece 3 is clamped by the conductive pins 2, the first cotton piece 3 can be attached to the heating piece 1 so well that gaps can be avoided.

The aforementioned descriptions are only some embodiments of the present disclosure and are not intended to limit the present disclosure. Any modifications, equivalent replacements and improvements made within the spirit and principles of the present disclosure shall be included in the range of protection of the present disclosure.

1. An atomizing structure, comprising:
a conductive pin comprising a fixing portion, a bending portion, and a clamping portion, and the bending portion connecting the fixing portion and the clamping portion; and
a heating piece fixedly connected to the fixing portion, wherein a gap between the clamping portion and the heating piece is configured to clamp a first cotton piece,
wherein the first cotton piece is attached to the heating piece, the heating piece generates heat to evaporate and atomize liquid absorbed by the first cotton piece, and a side of the first cotton piece away from the heating piece is configured to attach to a second cotton piece.

2. The atomizing structure according to claim 1, wherein two conductive pins are located at both ends of the heating piece, respectively, and lower parts of the two conductive pins are configured to connect an anode and a cathode of a power supply, respectively.

3. The atomizing structure according to claim 1, wherein the heating piece has an inner side and an outer side, and the fixing portion is welded on the outer side of the heating piece.

4. The atomizing structure according to claim 3, wherein the heating piece comprises a metal mesh and two electrode portions located on both sides of the metal mesh, respectively, the electrode portions and the clamping portion are parallel to each other, and the fixing portion is welded on a side of the electrode portion away from the clamping portion.

5. The atomizing structure according to claim 1, wherein the bending portion is located on an upper portion of the conductive pin, the clamping portion is located in a middle portion of the conductive pin, and the bending portion is formed by bending the fixing portion inward by 90°-180° toward a direction close to the clamping portion.

6. The atomizing structure according to claim 1, further comprising a packaging body, wherein the first cotton piece and the second cotton piece are connected end to end to form an annular shape, the packaging body surrounds the second cotton piece, a middle portion of an annular first cotton piece forms an airflow channel.

7. A method of manufacturing an atomizing structure, comprising:
connecting one end of a conductive pin to a heating piece;
bending the conductive pin to form a gap between a clamping portion of the conductive pin and the heating piece;
inserting a first cotton piece into the gap between the clamping portion and the heating piece; and
further bending the conductive pin, wherein the first cotton piece is clamped between the clamping portion and the heating piece.

8. The method according to claim 7, further comprising:
attaching a second cotton piece to a side of the first cotton piece away from the heating piece.

9. The method according to claim 8, further comprising:
processing the first cotton piece and the second cotton piece into an annular shape via an auxiliary jig; and
placing an annular first cotton piece, the annular second cotton piece, the annular heating piece, and the auxiliary jig in a packaging body, removing the auxiliary jig, wherein the second cotton piece abuts against an inner side of the packaging body.

10. A method of manufacturing the atomizing structure according to claim 1, comprising:
forming a gap between the first cotton piece and the second cotton piece;
inserting the clamping portion into the gap between the first cotton piece and the second cotton piece; and
bringing the clamping portion and the heating piece close to each other, wherein the clamping portion and a heating piece clamp the first cotton piece.
